(19) United States
(12) Patent Application Publication
(10) Pub. No.: US 2017/0030487 A1
(43) Pub. Date: Feb. 2, 2017

(54) CAPTIVATED CLAMP

(71) Applicant: FRANKLIN FASTENER COMPANY, Redford, MI (US)

(72) Inventor: James M. SAMPSON, Southfield, MI (US)

(21) Appl. No.: 15/230,781

(22) Filed: Aug. 8, 2016

Related U.S. Application Data
(62) Division of application No. 14/810,654, filed on Jul. 28, 2015.

(51) Int. Cl. F16L 3/10; B60R 16/02; F16L 3/223

(52) U.S. Cl. CPC F16L 3/1083; F16L 3/223; F16L 3/1066; F16L 3/1058; B60R 16/0222

(57) ABSTRACT

A captivating clamp assembly includes a base clamp and a retainer clamp that are connected by a T-shaped end received in a U-shaped opening. A bendable tab is offset relative to the transversely adjacent portions of the clamp assembly in an assembly position. The bendable tab interlocks the T-shaped end in a passageway in a retention position. A grommet may be assembled between the base clamp and retainer clamp for holding elongated members on a support structure.

### CROSS-REFERENCE TO RELATED APPLICATIONS

This application is a division of U.S. application Ser. No. 14/810,654 filed Jul. 28, 2015, the disclosure of which is hereby incorporated in its entirety by reference herein.

### TECHNICAL FIELD

This disclosure relates to a pre-assembled clamp for attaching elongated members to a supporting structure.

### BACKGROUND

Interlocking clamps are used to secure elongated members such as tubes, conduits, hoses and wiring to a support such as an engine, transmission, body or frame of a vehicle or other structure. Interlocking clamps may include two or more parts that are assembled together and attached to a supporting structure. A grommet may be provided inside the interlocking clamps to reduce vibration and securely hold elongated members. Two part clamps are opened to receive the elongated members and are assembled together to secure elongated members to supporting structures.

One problem with one piece clamps is that they may be difficult to quickly assemble over elongated members and attach to supporting structures on an assembly line. Two-part clamps may be pre-assembled prior to being provided to a line to facilitate final assembly of clamps to supporting structures. Pre-assembled interlocking clamps may become separated during shipping or handling. Assembly line downtime may occur if pre-assembled interlocking clamps become separated when provided to an assembly line that is set-up to install pre-assembled interlocking clamps.

The above problems and other problems are addressed by this disclosure as summarized below.

### SUMMARY

According to one aspect of this disclosure, a clamp assembly is disclosed that includes a base clamp part and a retainer clamp part. The base clamp part has an elongated portion disposed in a plane and a T-shaped engagement end. An attachment flange is provided on an opposite end of the elongated portion from the engagement end. The retainer clamp part has a longitudinal axis and a transverse axis with an engaged end defining an opening and including a bendable tab that is movable from an assembly position to a retention position. The bendable tab is disposed in the opening to form a U-shaped opening with the tab aligned with transversely adjacent portions of the engaged end in the retention position. The tab has a distal end that is offset relative to the transversely adjacent portions of the engaged end in the assembly position. The T-shaped engagement end is retained in the U-shaped opening by the tab in the retention position and is insertable and removable from the U-shaped opening in the assembly position. Pre-assembled captivating clamps made according to this disclosure facilitate final assembly because they are prevented from becoming separated during assembly and are more ergonomic

According to a further aspect of this disclosure as it relates to a clamp assembly, the clamp assembly may comprise a base clamp and a retainer clamp part. The base clamp part may have a T-shaped engagement end including a neck portion and two ears. The retainer clamp part may have an engaged end defining a U-shaped opening and a passageway that opens into or is part of the U-shaped opening. The retainer clamp part includes a tab extending from a side of the U-shaped opening opposite the passageway that partially defines the U-shaped opening in a retention position. The tab has a distal end disposed adjacent the passageway with the neck portion being retained in the passageway by the tab and the ears in the retention position.

According to other aspects of this disclosure as it relates the clamp assembly, the T-shaped engagement end may be prevented from rotating within or being dislodged from the U-shaped opening in the retention position. The T-shaped engagement end may be rotatable within the U-shaped opening in the assembly position. The retainer clamp part may have a second attachment flange on an opposite longitudinal end from the engaged end that is secured to the attachment flange in the retention position. The first attachment flange defines a first opening and the second attachment flange defines a second opening. A fastener may be inserted through the first opening and the second opening to secure the clamp assembly to a supporting body.

The clamp assembly may further comprise a grommet assembled between the base clamp part and the retainer clamp part that defines at least one opening defined by a first clam shell portion and a second clam shell portion for receiving an elongated member. The grommet may include at least one plug, or knob, and the retainer clamp part may define a plug receiving opening for receiving the plug to retain the grommet in the clamp assembly. As used herein the term “plug” should be understood to include knobs or similar structures that may be retained in an opening to hold the grommet in the retainer clamp.

In one embodiment, the retainer clamp part may include a central portion that includes a portion parallel to and spaced from the elongated portion of the base clamp and a first spacer leg and a second spacer leg extending from the central portion toward the elongated portion. Alternatively, the retainer clamp part may include a central portion that defines a partially curved space relative to the elongated portion.

According to another aspect of this disclosure, a method of assembling a clamp is disclosed whereby a base clamp part is assembled to a retainer clamp part and then secured together by bending a tab that prevents disassembly by rotation of the parts. The method begins by providing a base clamp part having an elongated portion disposed in a plane that includes a T-shaped engagement end that is offset from the plane in a direction normal to the plane, and an attachment flange on an opposite end of the elongated portion. A retainer clamp part is provided that has a longitudinal axis and a transverse axis with an engaged end defining an opening and a bendable tab having a distal end extending into the opening. The tab is offset relative to transversely adjacent portions of the engaged end in an assembly position. The T-shaped engagement end is then inserted into the opening. The T-shaped engagement end is inserted in the opening to align the elongated portion of the base clamp with the longitudinal axis. The tab is then bent into the opening to form a U-shaped opening with the tab aligned with transversely adjacent portions of the engaged end in a retention position. The tab prevents rotating the T-shaped end within the U-shaped opening in the retention position.

The method may further comprise providing a grommet formed of an elastomeric material that includes at least one protruding plug, or knob, and assembling the grommet between the base clamp part and the retainer clamp part. The retainer clamp part may define a plug receptacle and the plug may be inserted into the plug receptacle to secure the grommet within the clamp.

According to other aspects of the method, the method may further comprise providing a grommet formed of an elastomeric material and assembling the grommet between the base clamp part and the retainer clamp part.

The base clamp part may define a base fastener opening and the retainer clamp part may define a retention fastener opening and the method may further comprise providing a fastener and a supporting member. The fastener is inserted into the base fastener opening and the retention fastener opening to secure the clamp to the supporting member.

Pre-assembled captivated clamps made according to this disclosure stay together as they are shipped to a manufacturing plant and do not become separated during shipment and storage for service parts applications.

Pre-assembled captivated clamps made according to this disclosure are more ergonomic than one-piece clamps that are more difficult to close over an elongated article such as a tube, conduit, hose or wiring that is intended to be attached to a supporting structure such as an engine, transmission, body or frame of a vehicle, or other structure.

The above aspects of this disclosure and other aspects will be described below with reference to the attached drawings.

### BRIEF DESCRIPTION OF THE DRAWINGS

FIG. 1 is an exploded perspective view of a captivating clamp having a generally block-shaped grommet that defines three openings for receiving elongated articles.

FIG. 2 is a perspective view of the captivating clamp shown in FIG. 1 in an assembly position.

FIG. 3 is a perspective view of the captivating clamp shown in FIG. 1 in a retention position.

FIGS. 4-6 are a series of elevation views of the captivating clamp shown in FIG. 1 showing a base clamp part being assembled to a retainer clamp part with the grommet attached to the retainer clamp part.

FIGS. 7-10 are a series of perspective views of an alternative embodiment of a captivating clamp for a cylindrical elongated article showing a base clamp part being assembled to a retainer clamp part.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

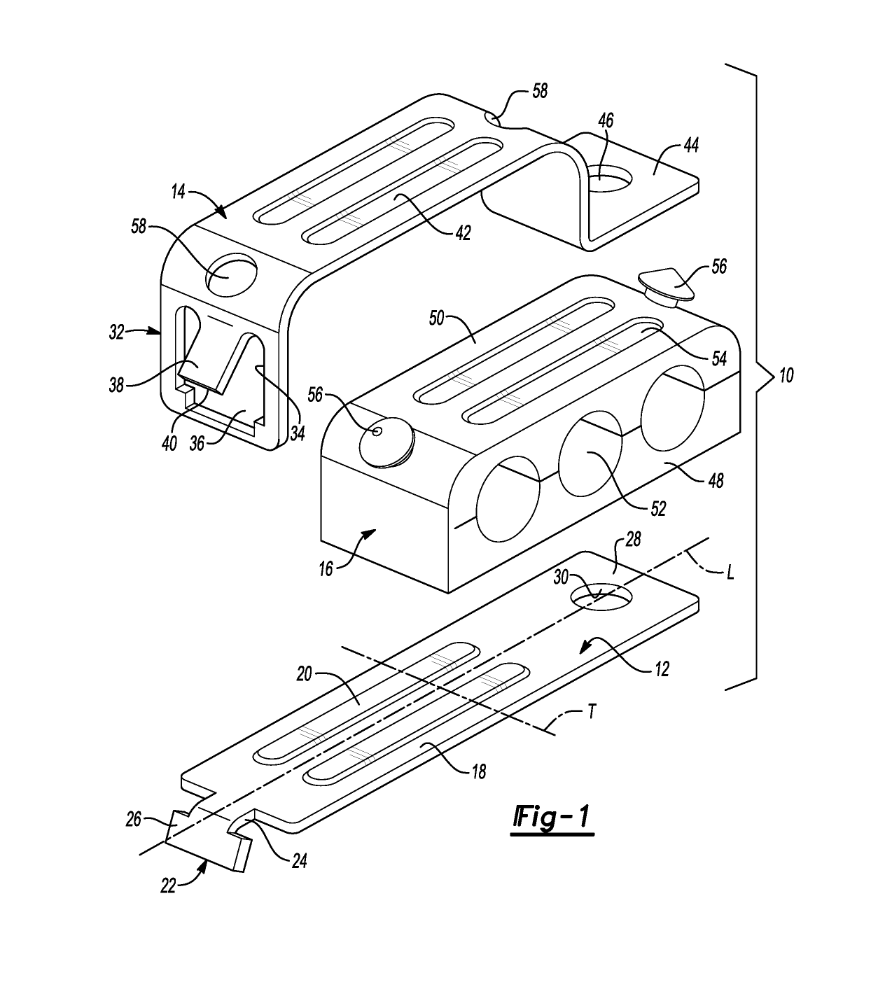

Referring to FIGS. 1-3, a clamp assembly 10 is illustrated that includes a base clamp part 12, a retainer clamp part 14 and a grommet 16. The clamp assembly 10 is assembled over an elongated article, such as a tube, conduit, hose or wiring that is intended to be attached to a supporting structure such as an engine, transmission, body or frame of a vehicle, or other structure.

The base clamp part 12 includes an elongated portion 18 that is provided with two ribs 20. The ribs 20 engage indentations (not shown) formed on the bottom of the grommet 16. The ribs 20 are provided to prevent the grommet 16 from becoming dislodged from the base clamp part 12 and to strengthen the clamp. The base clamp part 12 includes a T-shaped engagement end 22. The T-shaped engagement end 22 includes a neck portion 24 and ears 26 that are formed in the generally T-shaped portion of the base clamp part 12. An attachment flange 28 is provided on the opposite end of the base clamp part 12 from the T-shaped engagement end 22. The attachment flange 28 defines an opening 30 that is adapted to receive a fastener (not shown) that is used to attach the clamp assembly 10 to a supporting structure. As shown in FIG. 1, the base clamp part 12 of the clamp assembly 10 has a longitudinal axis “L” and a transverse axis “T”.

The retainer clamp part 14 includes an engaged end 32 that is engaged by the T-shaped engagement end 22 of the base clamp part 12. The engaged end 32 defines a U-shaped opening 34. A passageway 36 is formed to open into the U-shaped opening 34 on the opposite side of the U-shaped opening 34 from a locking tab 38. Locking tab 38 includes a distal end 40. The locking tab 38 is offset from transversely adjacent portions 41 of the engaged end 32 in an assembly position and is aligned with the transversely adjacent portions 41 in the retention position. The retainer clamp part 14 includes two ribs 42 that correspond to the ribs 20 formed on the base clamp part 12. The ribs 20, 42 function to facilitate retaining the grommet 16 within the clamp assembly 10. The retention clamp part 14 also includes an attachment end 44 that defines an opening 46. Opening 46 is aligned with opening 30 in the base clamp part 12 to receive a fastener (not shown) as previously described.

The grommet 16 includes a base 48 and a cap 50. The grommet 16 is preferably an elastomeric or plastic member. The base 48 and cap 50 are connected together by a living hinge area. The base 48 and cap 50 are separated to receive articles, such as elongated wires, tubes or conduits within one or more article openings 52. As shown in FIGS. 1-3, three article openings are provided in the grommet 16, but it should be understood that one or more article openings may be provided within the scope of this disclosure. Indentations 54 are shown on the cap 50 of the grommet 16. The indentations 54 are adapted to receive the ribs 42 that are formed inside the retainer clamp part 14. Similar indentations (not shown) are provided on the bottom of the base 48 of the grommet 16 for receiving the ribs 20 formed inside the base clamp part 12. The grommet 16 includes at least one plug 56 that is inserted into a plug receiving opening 58 defined in the retainer clamp part 14.

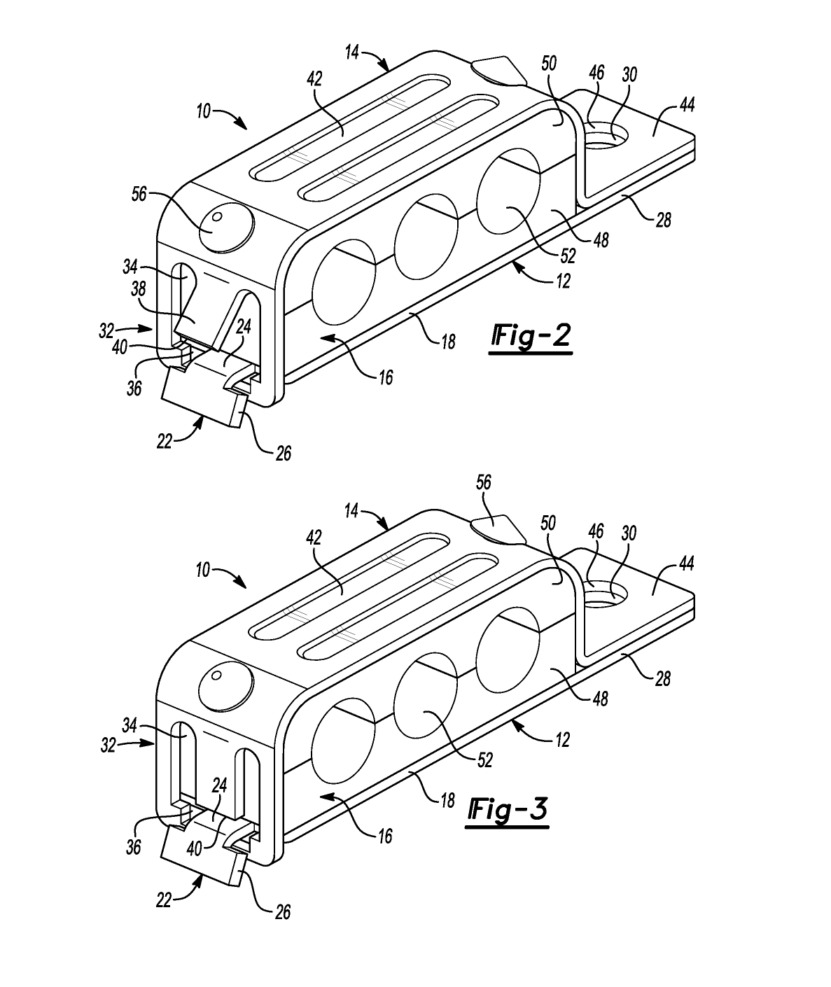

Referring to FIG. 2, the clamp assembly 10 is shown in a partially pre-assembled condition, or assembly position, in which the locking tab 38 is offset relative to laterally adjacent portions of the engaged end 32. In FIG. 3, the clamp assembly 10 is shown in the retention position with the locking tab 38 being bent to conform to the laterally adjacent portions of the engaged end 32. The distal end 40 of the locking tab 38 holds the T-shaped engagement end 22 in the channel 36.

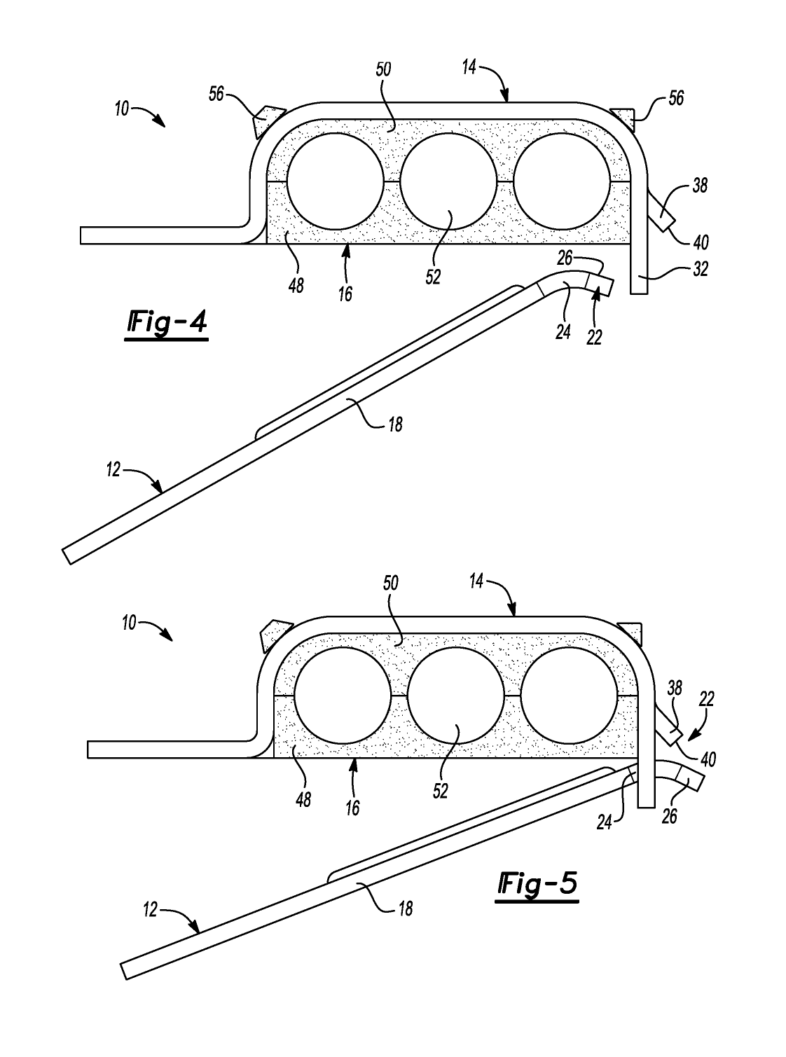

Referring to FIGS. 4-6, assembly of the base clamp part 12 and retainer clamp part 14 with a grommet 16 is described. Referring to FIG. 4, the base clamp part 12 is shown with the T-shaped engagement end 22 including the neck portion 24 and ears 26 is shown in a spaced relationship relative to the retainer clamp part 14. The grommet 16 is shown secured to the retainer clamp part 14 by the plug 56. The grommet 16 defines three article openings 52 between the base 48 and cap 50 of the grommet 16. The locking tab 38 is shown to be offset relative to the transversely adjacent portions of the engaged end 32 of the retainer clamp part 14. The distal end 40 of the tab 38 is offset to provide space within the U-shaped opening 34 for receiving the T-shaped engagement end 22 of the base clamp part 12.

Referring to FIG. 5, the base clamp part 12 is shown with the T-shaped engagement end 22 received within the passageway 36 (shown in FIGS. 1-3). The ears 26 of the T-shaped engagement end 22 are disposed on the opposite side of the retainer clamp part 14 from the elongated portion 18 of the base clamp part 12. The neck portion 24 is received in the passageway 36.

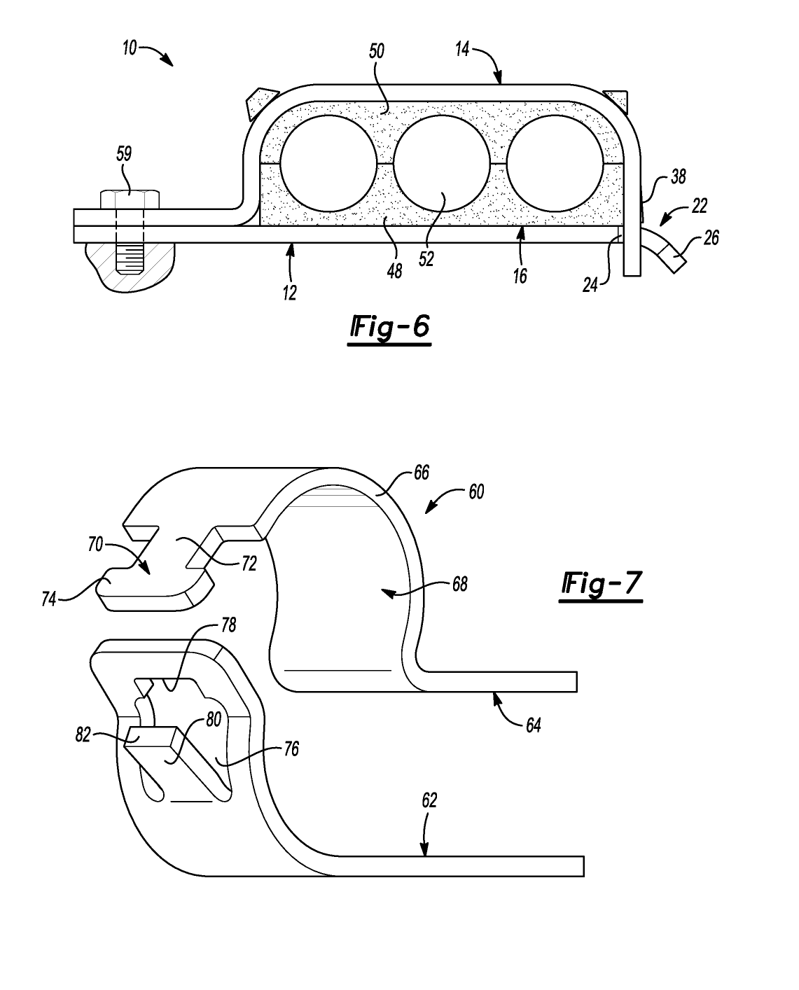

Referring to FIG. 6, the clamp assembly 10 is shown fully assembled and attached with a fastener 59 attaching the clamp assembly 10 to a supporting surface. The base clamp part 12 and retainer clamp part 14 are secured together by the T-shaped engagement end 22 that is received in the passageway 36. The locking tab 38 in the retention position is in alignment with the transversely adjacent portions of the engaged end on one end. On the other end of the clamp assembly 10, the fastener 59 is received in the openings 30, 46 defined by the base clamp part 12 and retainer clamp part 14. The base 48 and cap 50 of the grommet 16 are held together by the base clamp part 12 and the retainer clamp part 14. The base 48 and cap 50 of the grommet 16 define three article openings 52 that are adapted to receive elongated members, such as tubing, wiring, conduit, or the like.

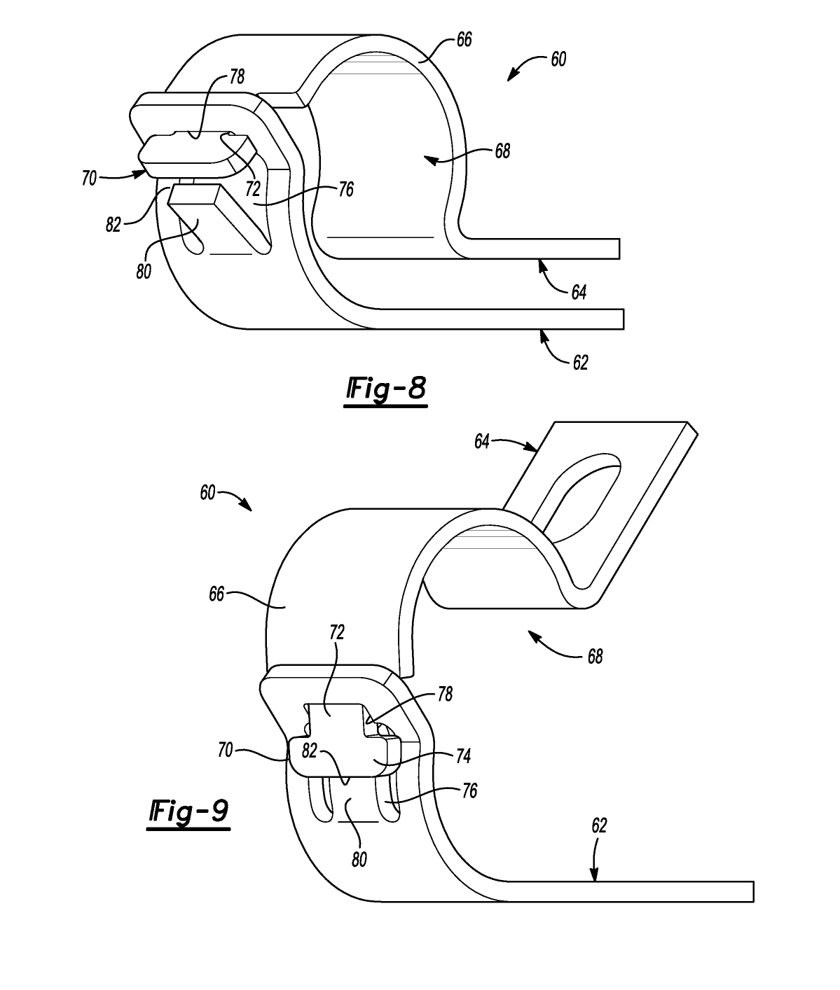

Referring to FIGS. 7-10, an alternative embodiment of a clamp assembly is generally indicated by reference numeral 60. Clamp assembly 60 is shown in FIGS. 7-10 as it is assembled together. Clamp assembly 60, as illustrated, does not include a grommet; however, a grommet could be included in this embodiment if desired. The retainer clamp 64 includes a semi-cylindrical wall 66 that defines a partially curved space 68. The semi-cylindrical wall 66 is curved to accommodate a pipe, conduit or the like that has a cylindrical outer surface. A T-shaped engagement end 70 is provided on the retainer clamp 64. The T-shaped engagement end 70 includes a neck portion 72 and two oppositely oriented ears 74. The base clamp 62 defines a U-shaped opening 76 and a passageway 78 that opens into the U-shaped opening 76. A locking tab 80 is provided within the U-shaped opening in the base clamp 62. The locking tab 80 includes a distal end 82. The distal end 82 is bent from the position shown in FIGS. 7 and 8 to engage the neck portion 72 of the T-shaped engagement end 70 of the retainer clamp 64.

Referring to FIG. 7, the clamp assembly 60 is shown to include two separate parts comprising the base clamp 62 and the retainer clamp 64. The base clamp 62 is shown with the locking tab 80 bent outwardly from the U-shaped opening 76. This position is referred to as the assembly position.

Referring to FIG. 8, the clamp assembly 60 is shown with the retainer clamp 64 partially assembled to the base clamp 62. The T-shaped engagement end 70 is assembled to the base clamp 62 with the neck portion 72 received in the passageway 78. The locking tab 80 is initially bent outwardly from the U-shaped opening 76. The distal end 82 of the locking tab 80 does not engage the T-shaped engagement end 70 in the assembly position.

Referring to FIG. 9, the clamp assembly 60 is shown in an open position after the locking tab 80 is bent to retain the neck portion 72 of the T-shaped engagement end 70. The clamp assembly 60 is provided to the assembly line in an openable condition with the base clamp 62 and retainer clamp 64 interlocked together. The clamp assembly 60 is opened to receive an elongated member. The neck portion 72 is trapped within the passageway 78 by the distal end 82 of the locking tab 80. In this position, the retainer clamp 64 is not rotatable within the U-shaped opening 76 and disassembly of the base clamp 62 from the retainer clamp 64 is prevented.

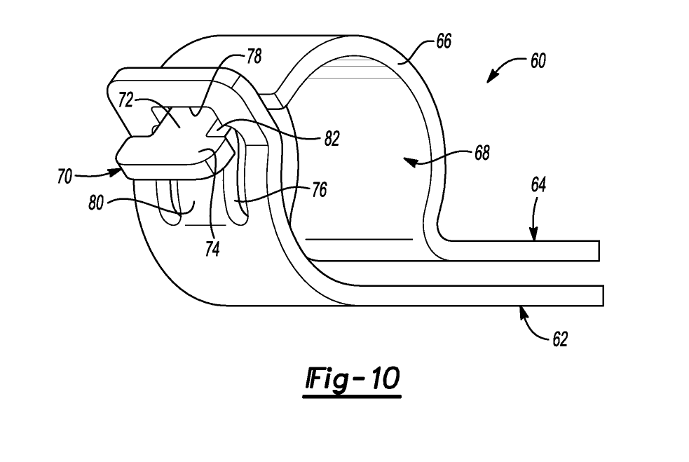

Referring to FIG. 10, the clamp assembly 60 is shown in a closed position, or retention position, wherein the base clamp 62 and the retainer clamp 64 may be secured to a support. The clamp assembly 60, as shown in FIGS. 9 and 10, is in the retention position and can be transported or handled without any risk of detaching the retainer clamp 64 from the base clamp 62.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1. A clamp assembly comprising:
a base clamp part having an elongated portion disposed in a plane and a T-shaped engagement end and a first attachment flange on an opposite end of the elongated portion from the engagement end;
a retainer clamp part having an engaged end defining an opening and including a bendable tab that is movable from an assembly position to a retention position, the bendable tab being disposed in the opening to form a U-shaped opening with the tab aligned with transversely adjacent portions of the engaged end in the retention position, wherein the tab has a distal end disposed offset relative to the transversely adjacent portions of the engaged end in the assembly position, wherein the T-shaped engagement end is retained in the U-shaped opening by the tab in the retention position and is inserted and removed from the U-shaped opening in the assembly position; and
a grommet assembled between the base clamp part and the retainer clamp part that defines at least one opening defined by a first clam shell portion and a second clam shell portion for receiving an elongated member.

2. The clamp assembly of claim 1 wherein the T-shaped engagement end is prevented from rotating within the U-shaped opening in the retention position.

3. The clamp assembly of claim 1 wherein the T-shaped engagement end is rotatable within the U-shaped opening in the assembly position.

4. The clamp assembly of claim 1 wherein the retainer clamp part has a second attachment flange on an opposite longitudinal end from the engaged end that is secured to the first attachment flange in the retention position.

5. The clamp assembly of claim 4 wherein the first attachment flange defines a first opening and the second attachment flange defines a second opening, and wherein a fastener is inserted through the first opening and the second opening to secure the clamp assembly to a supporting body.

6. (canceled)

7. The clamp assembly of claim 1 wherein the grommet includes at least one plug, and the retainer clamp part defines a plug receiving opening for receiving the plug to retain the grommet in the clamp assembly.

8. The clamp assembly of claim 1 wherein the retainer clamp part includes a central portion that includes a portion parallel to and spaced from the elongated portion of the base clamp part and a first spacer leg and a second spacer leg extending from the central portion toward the elongated portion.

9. The clamp assembly of claim 1 wherein the retainer clamp part includes a central portion that defines a partially curved space relative to the elongated portion.

10. A clamp assembly comprising:
a base clamp part having a T-shaped engagement end including a neck portion and two ears;
a retainer clamp part having an engaged end defining an U-shaped opening and a passageway that opens into the U-shaped opening, the retainer clamp part including a tab extending from a side of the U-shaped opening opposite the passageway and that partially defines the U-shaped opening in a retention position, and wherein a distal end of the tab is offset from the passageway in an assembly position, wherein the neck portion is retained in the passageway by the tab and the ears in the retention position; and
a grommet assembled between the base clamp part and the retainer clamp part that defines at least one opening defined by a first clam shell portion and a second clam shell portion for receiving an elongated member.

11. The clamp assembly of claim 10 wherein the T-shaped engagement end is prevented from rotating within the U-shaped opening in the retention position.

12. (canceled)

13. The clamp assembly of claim 10 wherein the grommet includes at least one plug (or knob), and the retainer clamp part defines a plug receiving opening for receiving the plug (or knob) to retain the grommet in the clamp assembly.

14. A method of assembling a clamp comprising:
providing a base clamp part having an elongated portion disposed in a plane, a T-shaped engagement end that is offset from the plane in a direction normal to the plane, and an attachment flange on an opposite end of the elongated portion;
providing a retainer clamp part having a longitudinal axis and a transverse axis with an engaged end defining an opening and a bendable tab having a distal end extending into the opening, with the tab being disposed offset relative to transversely adjacent portions of the engaged end in an assembly position;
inserting the T-shaped engagement end into the opening;
aligning the T-shaped engagement end within the opening with the elongated portion of the base clamp part with the longitudinal axis;
bending the tab into the opening to form a U-shaped opening with the tab aligned with transversely adjacent portions of the engaged end in a retention position, wherein the T-shaped engagement end is prevented from rotating by the tab;
providing a grommet formed of an elastomeric material that includes at least one protruding plug; and
assembling the grommet between the base clamp part and the retainer clamp part, wherein the retainer clamp part defines a plug receptacle, and wherein the plug is inserted into the plug receptacle to secure the grommet within the clamp.

15. (canceled)

16. The method of claim 14 wherein the retainer clamp part defines a plurality of plug receptacles, and wherein the at least one protruding plug includes a plurality of protruding plugs that are each inserted into one of a plurality of plug receptacles to secure the grommet within the clamp.

17. (canceled)

18. The method of claim 14 wherein the base clamp part defines a base fastener opening and the retainer clamp part defines a retention fastener opening, the method further comprising:
providing a fastener;
providing a supporting member; and
inserting the fastener into the base fastener opening and the retention fastener opening to secure the clamp to the supporting member.

19. The method of claim 14 wherein the grommet defines at least one article receiving opening extending through the grommet in a direction parallel to the transverse axis of the retainer clamp part.

20. The method of claim 14 wherein the grommet defines a plurality of article receiving openings extending through the grommet in a direction parallel to the transverse axis of the retainer clamp part.
